(19) United States
(12) Patent Application Publication
(10) Pub. No.: US 2012/0265588 A1
(43) Pub. Date: Oct. 18, 2012

(54) SYSTEM AND METHOD FOR RECOMMENDING NEW CONNECTIONS IN AN ADVERTISING EXCHANGE

(76) Inventors: Ashvin Kannan, Sunnyvale, CA (US); Ajay Shekhawat, San Francisco, CA (US)

(21) Appl. No.: 13/085,390

(22) Filed: Apr. 12, 2011

(51) Int. Cl. G06Q 30/00

(52) U.S. Cl. 705/14.4

(57) ABSTRACT

A method, system and computer readable medium for recommending new connections in an advertising exchange. The method identifies participants that share some similarity (e.g. a pre-existing advertising relationship), and on the basis of the features and extent of a similarity, and then suggests or recommends other relationships that can also be shared. The method commences by enumerating a set of producer participants and by enumerating a set of consumer participants where at least two of the members of the set of consumer participants has an ad relationship to at least one of the producer participants. Then, on the basis of a selected feature quantity the extent of the similarity is calculated. When it is found that one consumer is similar to a second consumer (by virtue of at least one shared ad relationship), then the system recommends to the participants one or more additional ad relationships that can be established.

### FIELD OF THE INVENTION

The present invention is related to the field of ad delivery systems and is more specifically directed to methods for recommending connections within an advertising exchange.

### BACKGROUND OF THE INVENTION

Electronic exchanges, including online auctions, have proliferated along with the Internet. These electronic exchanges aim to provide a high degree of trading efficiency by bringing together a large number of sellers (e.g. producers in the exchange) and buyers (e.g. consumers in the exchange). Such centralized exchanges are generally focused on matching the bids and offers of buyers and sellers. Conventional transactions on the exchange are between (i) buyers and sellers, (ii) intermediaries (e.g. brokers, which may be a buyer or seller), or (iii) buyers or sellers and intermediaries.

The proliferation of Internet activity has also generated tremendous growth in advertising on the Internet. Typically, advertisers (e.g. consumers of ad space) and online publishers (e.g. producers of ad space) have agreements with one or more advertising networks (aka, ad networks), which provide for serving an advertiser's banner or ad across multiple publishers, and concomitantly provide for each publisher having access to a potentially large number of advertisers. Ad networks, may also manage payment and reporting, may also attempt to target certain users with particular advertisements to increase the likelihood that the user will take an action with respect to the advertisement.

In most advertising exchanges, publishers and advertisers form one-on-one business relationships, where the advertiser's advertisements or listings can be shown on, near, or within a publisher's published materials.

In legacy systems, establishing an ad relationship between two parties involves substantial manual processing. However with hundreds or thousands (or more), participants in a modern display advertising exchange, it is time-consuming for a participant to hunt around for other participants with whom it should connect. How does one find other entities with whom it should connect? How does one select them for making new ad relationships and/or other connections? The manual processes do not scale as the number of participants in the advertising exchange grows; however, the problem can be mitigated if there were an automated way for making recommendations of new connections in an advertising exchange.

Thus, what is needed are techniques for recommending new connections in an advertising exchange. Other automated features and advantages of the present invention will be apparent from the accompanying drawings and from the detailed description that follows below.

### SUMMARY OF THE INVENTION

A method, system and computer readable medium for recommending new connections in an advertising exchange. The method identifies participants that share some similarity (e.g. a pre-existing advertising relationship), and on the basis of the features and extent of a similarity, and then suggests or recommends other relationships that can also be shared. The method commences by enumerating a set of producer participants and by enumerating a set of consumer participants where at least two of the members of the set of consumer participants has an ad relationship to at least one of the producer participants. Then, on the basis of a selected feature quantity the extent of the similarity is calculated. When it is found that one consumer is similar to a second consumer (by virtue of at least one shared ad relationship), then the system recommends to the participants one or more additional ad relationships that can be established.

### BRIEF DESCRIPTION OF THE DRAWINGS

A brief description of the drawings follows:

FIG. 1A shows an advertising network environment depicted as a directed graph, in which some embodiments operate

FIG. 1B shows a directed graph, and includes labeling of the source node(s) and destination node(s), in which some embodiments operate.

FIG. 1C shows an advertising network environment including an intermediary, in which some embodiments operate.

FIG. 2A shows multiple advertising relationship graphs, showing a path from a buyer to a seller through an intermediary, in which some embodiments operate.

FIG. 2B shows advertising relationship graphs, showing a path from a buyer to a seller through an intermediary, and including a representation of ad relationships, in which some embodiments operate.

FIG. 2C shows a representation of relationships between publishers and advertisers in the form of an ad relationship graph, in which some embodiments operate.

FIG. 2D shows a representation of relationships between ecosystem participants in the form of vectors, in which some embodiments operate.

FIG. 3A shows selected modules of an advertising server network environment including modules for recommending new connections in an advertising exchange, in which some embodiments operate.

FIG. 3B shows an advertising server network environment including modules for recommending new connections in an advertising exchange in display advertising systems, in which some embodiments operate.

FIG. 4A shows a system for recommending an advertiser to a publisher, in which some embodiments operate.

FIG. 4B shows a system for recommending a publisher to an advertiser, in which some embodiments operate.

FIG. 5 shows aspects of a relationship graph for recommending a consumer to a producer, in which some embodiments operate.

FIG. 6 shows system for recommending a consumer to a producer, in which some embodiments operate.

FIG. 7 is a diagrammatic representation of a network including nodes for client computer systems, nodes for server computer systems and nodes for network infrastructure, according to some embodiments.

### DETAILED DESCRIPTION

In the following description, numerous details are set forth for purpose of explanation. However, one of ordinary skill in the art will realize that the invention may be practiced without the use of these specific details. In other instances, well-known structures and devices are shown in block diagram form in order to not obscure the description of the invention with unnecessary detail.

### DEFINITIONS

Some of the terms used in this description are defined below (in alphabetical order) for easy reference. These terms are not rigidly restricted to these definitions. A term may be further defined by the term's use in other sections of this description.

“Ad” (e.g. ad, item and/or message) means a paid announcement, as of goods or services for sale, preferably on a network such as the internet. An ad may also be referred to as an item and/or a message.

“Ad call” means a message sent by a computer to an ad server for requesting an ad to be displayed.

“Ad click-through rate” (e.g. click-through rate) means a measurement of ad clicks per a period of time.

“Ad server” is a server that is configured for serving one or more ads to user devices. An ad server is preferably controlled by a publisher of a website and/or an advertiser of online ads. A server is defined below.

“Advertiser” (e.g. messenger and/or messaging customer, etc) means an entity that is in the business of marketing a product and/or a service to users. An advertiser may include, without limitation, a seller and/or a third-party agent for the seller. An advertiser may also be referred to as a messenger and/or a messaging customer. Advertising may also be referred to as messaging.

“Advertising” means marketing a product and/or service to one or more potential consumers by using an ad. One example of advertising is publishing a sponsored search ad on a website.

“Application server” is a server that is configured for running one or more devices loaded on the application server. For example, an application server may run a device configured for deducing shadow profiles.

“Click” (e.g. ad click) means a selection of an ad impression by using a selection device such as, for example, a computer mouse or a touch-sensitive display.

“Client” means the client part of a client-server architecture. A client is typically a user device and/or an application that runs on a user device. A client typically relies on a server to perform some operations. For example, an email client is an application that enables a user to send and receive email via an email server. In this example, the computer running such an email client may also be referred to as a client.

“Conversion” (e.g. ad conversion) means a purchase of a product/service that happens as a result of a user responding to an ad and/or a coupon.

“Database” (e.g. database system, etc) means a collection of data organized in such a way that a computer program may quickly select desired pieces of the data. A database is an electronic filing system. In some instances, the term “database” is used as shorthand for a “database management system”. A database may be implemented as any type of data storage structure capable of providing for the retrieval and storage of a variety of data types. For instance, a database may include one or more accessible memory structures such as a CD-ROM, tape, digital storage library, flash drive, floppy disk, optical disk, magnetic-optical disk, erasable programmable read-only memory (EPROM), random access memory (RAM), magnetic or optical cards, etc.

“Device” means hardware, software or a combination thereof. A device may sometimes be referred to as an apparatus. Examples of a device include, without limitation, a software application such as Microsoft Word™ or a database; or hardware such as a laptop computer, a server, a display; or a computer mouse and/or a hard disk.

“Impression” (e.g. ad impression) means a delivery of an ad to a user device for viewing by a user.

“Item” means an ad, which is defined above.

“Message” means an ad, which is defined above.

“Messaging” means advertising, which is defined above.

“Network” means a connection, between any two or more computers, that permits the transmission of data. A network may be any combination of networks including, without limitation, the internet, a local area network, a wide area network, a wireless network, and/or a cellular network.

“Publisher” means an entity that publishes, on a network, a web page having content and/or ads, etc.

“Server” means a software application that provides services to other computer programs (and their users) on the same computer or on another computer or computers. A server may also refer to the physical computer that has been set aside to run a specific server application. For example, when the software Apache HTTP Server is used as the web server for a company's website, the computer running Apache may also be called the web server. Server applications may be divided among server computers over an extreme range, depending upon the workload.

“Software” means a computer program that is written in a programming language that may be used by one of ordinary skill in the art. The programming language chosen should be compatible with the computer on which the software application is to be executed and, in particular, with the operating system of that computer. Examples of suitable programming languages include, without limitation, Object Pascal, C, C++ and/or Java. Further, the functions of some embodiments, when described as a series of steps for a method, could be implemented as a series of software instructions for being operated by a processor such that the embodiments could be implemented as software, hardware, or a combination thereof. Computer-readable media are discussed in more detail in a separate section below.

“System” means a device or multiple coupled devices. A device is defined above.

“User” (e.g. consumer, etc) means an operator of a user device. A user is typically a person who seeks to acquire a product and/or service. For example, a user may be a woman who is browsing Yahoo!™ Shopping for a new cell phone to replace her current cell phone. The term “user” may also refer to a user device, depending on the context.

“User device” (e.g. computer, user computer, client and/or server, etc) means a single computer or a network of interacting computers. A user device is a computer that a user may use to communicate with other devices over a network, such as the internet. A user device is a combination of a hardware system, a software operating system, and perhaps one or more software application programs. Examples of a user device include, without limitation, a laptop computer, a palmtop computer, a smart phone, a cell phone, a mobile phone, an IBM-type personal computer (PC) having an operating system such as Microsoft Windows™, an Apple™ computer having an operating system such as MAC-OS, hardware having a JAVA-OS operating system, and/or a Sun Microsystems™ workstation having a UNIX operating system.

“Web browser” means a software program that may display text or graphics or both, from web pages on websites. Examples of a web browser include, without limitation, Mozilla Firefox™ and Microsoft Internet Explorer™.

“Web page” means documents written in a mark-up language including, without limitation, HTML (hypertext mark-up language), VRML (virtual reality modeling language), dynamic HTML, XML (extensible mark-up language), and/or other related computer languages. A web page may also refer to a collection of such documents reachable through one specific internet address and/or through one specific website. A web page may also refer to any document obtainable through a particular URL (uniform resource locator).

“Web portal” (e.g. public portal) means a website or service that offers a broad array of resources and services such as, for example, email, forums, search engines, and online shopping malls. The first web portals were online services, such as AOL, that provided access to the web. However, now, most of the traditional search engines (e.g. Yahoo!™) have transformed themselves into web portals to attract and keep a larger audience.

“Web server” is a server configured for serving at least one web page to a web browser. An example of a web server is a Yahoo!™ web server. A server is defined above.

“Website” means one or more web pages. A website preferably includes a plurality of web pages virtually connected by links or URL addresses to form a coherent group.

### Introduction to Exchange Management

As indicated, what is needed are techniques for recommending new connections in an advertising exchange. Thus, below is described an advertising exchange, and components of a system that mines data (e.g. logs) for use in generating recommendations for publishers (to connect with advertisers) and for generating recommendations to advertisers (to connect with publishers). The systems described include an automated system which can recommend new connections for a publisher or an advertiser without any human intervention. This capability is motivated by the need for higher liquidity in the transactions within the advertising exchange, which higher liquidity can result in higher business performance for the exchange participants.

Even in the presence of an exchange (further described below), in some cases, online advertising markets exhibit undesirable inefficiencies when buyers and sellers are unable to identify each other for engaging in transactions. For instance, although a publisher may be subscribed to many ad networks, and one or more of those ad networks may transact inventory with other ad networks, it might be that only one of the ad networks to which the publisher is subscribed is involved in selling (or auctioning) a given ad space for the publisher. One approach is to allow an intermediary (e.g. an agency) into the ecosystem, where that intermediary is suited to find, select, and prioritize the inventory of ad calls on behalf of the agency's client.

In an alternate scenario, it happens that in some cases, although an advertiser may be subscribed to many ad networks, and one or more of those ad networks may transact advertising placements with other ad networks, it might be that only one of the ad networks to which the advertiser is subscribed is involved in offering ad space suitable for the advertiser's placements. Again, one approach is to allow an intermediary (e.g. an agency) into the ecosystem, where that intermediary is suited to find, select, and prioritize ad placements on behalf of the agency's client.

As indicated above, some embodiments of the invention operate within the context of an advertising exchange. More specifically, descriptions of embodiments of the invention involve advertising exchange concepts and include descriptions of network entities, an agency, an agency-on-exchange, an agency-within-ad-network, an agency-as-ad-network, and ad relationships (e.g. contracts, links, deals, and revenue sharing, etc).

Further, within the context of the foregoing embodiments, techniques disclosed herein facilitates new capabilities for network entities to establish relationships, and to conduct transactions while observing required functionalities, protections, and billing and reporting systems. These techniques are further described below.

### Publisher, Advertiser and Agency Overview

Advertising exchange network entities as discussed herein include real companies with real people making decisions and/or taking action on behalf of the entity or the entity's clients. In an active ecosystem, advertising exchange network entities seek to establish business relationships with other entities on the exchange (again, such entities comprising real companies with real people). More specifically, advertising exchange network entities can enter into advertising-related business deals and form advertising relationships with other entities on the exchange. Using the techniques described herein, a network entity's ad relationships can be represented as data items to be shared among the entities involved in a given transaction or series of transactions. As used within the context of the embodiments of the invention herein, these ad relationships (e.g. contracts, links, and deals, etc.) allow network entities to: (a) be granted access to certain ad network-related data pertaining to client accounts (e.g. an advertiser, a publisher), (b) specify a revenue sharing model for remuneration, and (c) act as a proxy for any invoicing and payments on behalf of their clients.

In a modern internet advertising system, there may be many thousands or hundreds of thousands (or more) entities, and the entities may conduct internet advertising business using a network exchange. As used herein, a network exchange serves to facilitate placement-related communication (e.g. which advertisements to place at what times) and a network exchange may also serve to facilitate business transactions (e.g. recording of occurrences of and characteristics of transactions). Embodiments of the invention herein provide for representing a network entity as an exchange seatholder, and such a seatholder may participate within the exchange by performing transactions through or with other exchange seatholders.

Network entities (e.g. seatholders, publishers, advertisers and agencies) enter into business relationships. As earlier indicated, in legacy practice, forming such relationships is a manual process, and consumes manpower and other resources in order to identify the party or parties with whom a new business relationship might be established, and as internet advertising grows in popularity, so does the need for establishing such business relationships. However, given the existence of many thousands or hundreds of thousands (or more) entities, the deployment of filtering-out techniques, or selecting-in techniques, or other techniques to identify suitable entities with whom to do advertising business becomes paramount.

Embodiments herein analyze various internet advertising datasets in order to make recommendations to an entity regarding which other entities might be candidates for a business relationship. Such a recommendation can be used to identify potential new relationships and suggest those recommended new relationships to the account managers. Additional business relationship within the exchange will allow the network to become more connected, thereby increasing liquidity and competition in the marketplace, and thereby increasing the volume of transactions possible.

### Definitions and Depiction of Exchange: Network Graphs, Directed Graphs

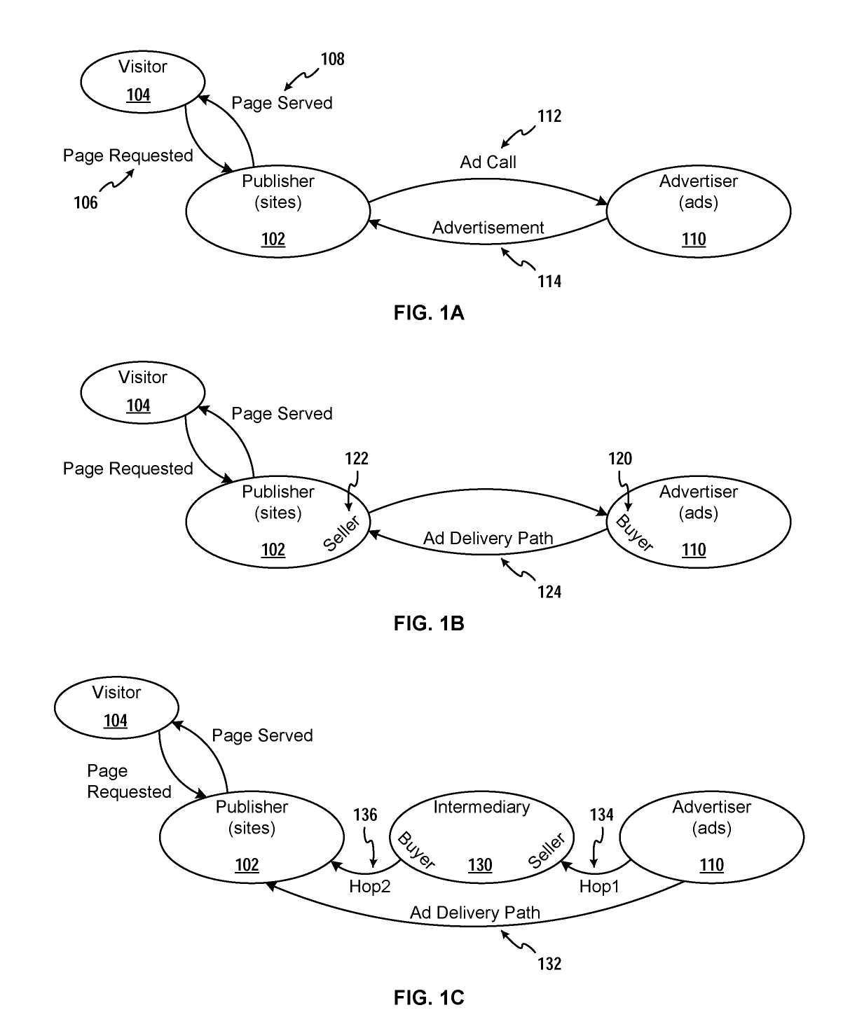

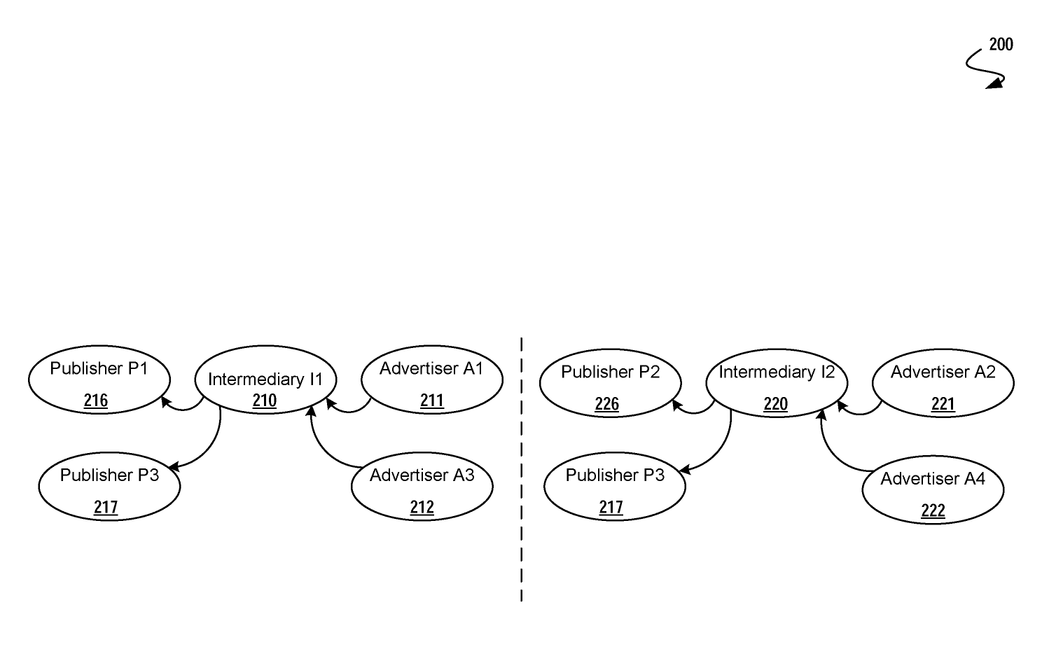

FIG. 1A shows an advertising network environment depicted as a directed graph wherein a publisher 102 of a site engages in serving pages to a web page visitor 104 (see page requested 106 and page served 108). Also shown is a publisher's interaction with an advertiser 110. In this simplified model, a visitor requests a page from the publisher 102. The publisher performs an ad call 112 to an advertiser, and the advertiser in turn supplies an advertisement 114 to the publisher. The page requested by the visitor is composited to include the advertisement, and the requested page is served to the visitor.

FIG. 1B shows the graph of FIG. 1A, and includes labeling of the source node (buyer 120) and destination node (seller 122) pertaining to the graph edge labeled as ad delivery path 124 which ad delivery path as shown begins with a buyer and ends with a seller.

FIG. 1C shows an advertising network environment including an intermediary 130. In this environment, the intermediary acts as both a consumer and a producer (i.e. as a buyer and as a seller). As shown, the ad delivery path 132 begins with the advertiser, and ends with the publisher as in FIG. 1A and FIG. 1B, and in this case, the ad delivery path is accomplished via two hops, hop1 134 and hop2 136.

So, with the above definitions, and for the purposes of understanding the disclosure herein, an ad delivery transaction on the exchange can be represented on a directed graph such as is shown in FIG. 1A, FIG. 1B, and FIG. 1C. For each ad delivery transaction the following assertions hold true:
An ad delivery transaction originates from an entity (e.g. a producer) and terminates at an entity (e.g. a consumer). The directed edge is referred to as a hop. One or more hops between graph nodes is a path.
A path may traverse through zero or more other nodes (e.g. agencies) on the exchange; each such node is considered to be an intermediary in the transaction.
A path may comprise several sub-paths or hops; each hop has a buyer end-point at the beginning (an entity) and a seller end-point (another entity) at the end.
The buyer end-point of the first such hop is termed the original buyer in the ad delivery transaction.
The seller end-point of the last hop is termed the original seller.
The transactions accomplished between the original seller and the original buyer are termed ad delivery transactions.

Now, for any ad delivery transaction, there may be zero, one, or more hops, and as introduced above, each hop has a producer (e.g. a seller) and a consumer (e.g. a buyer) and may also have an intermediary or agency. And, in some cases (as shown) an intermediary may serve as both a seller and as a buyer). Accordingly, a hop represents a transactional ad relationship between a buyer and a seller, even if not the original buyer and original seller. Such relationships may include an ad contract, a link, and possibly also a deal. Collectively these relationships as represented on the directed graph are known as ad relationships.

### Agency Role and Actions of Managing Advertisers and Managing Publishers

Agencies are entities on the exchange that perform activities on behalf of their customers. For example, a particular agency might represent a group of advertisers. Or a particular agency might represent a group of publishers. Such agencies have business relationships (e.g. under an ad relationship or an ad contract) with their constituents (e.g. their clients) to perform certain activities on behalf of their clients, and such activities can include actions to:

Place orders

Manage campaigns

Create ads

Manage links

Manage deals

Manage sites

View and interpret reports

Participate in billing and payment

Agencies may want to cooperate with other agencies, and may wish to establish interrelationships with other agencies or, more generally, may wish to establish interrelationships (e.g. ad relationships, ad contracts, deals, links) with other agencies. More specifically, an agency might be specialized in a certain advertising area, and might focus business operations on behalf of advertisers. Or, an agency might be specialized in a publishing area, and might focus business operations on behalf of publishers. As used herein, the term managing publisher (MP) refers to activities of an agency when representing one or more publishers. Similarly, the term managing advertiser (MA) refers to activities of an agency when representing one or more advertisers.

Thus, managing advertisers may want to establish ad relationships with managing publishers, and managing publishers may wish to establish ad relationships with managing advertisers. In fact, any managing entity may wish to establish interrelationships with any other managing entity(ies). More specifically, a managing entity may desire to establish interrelationships with other managing entities with whom a business relationship is likely to result in many transactions.

### Exchange Intermediaries: Concepts and Actions

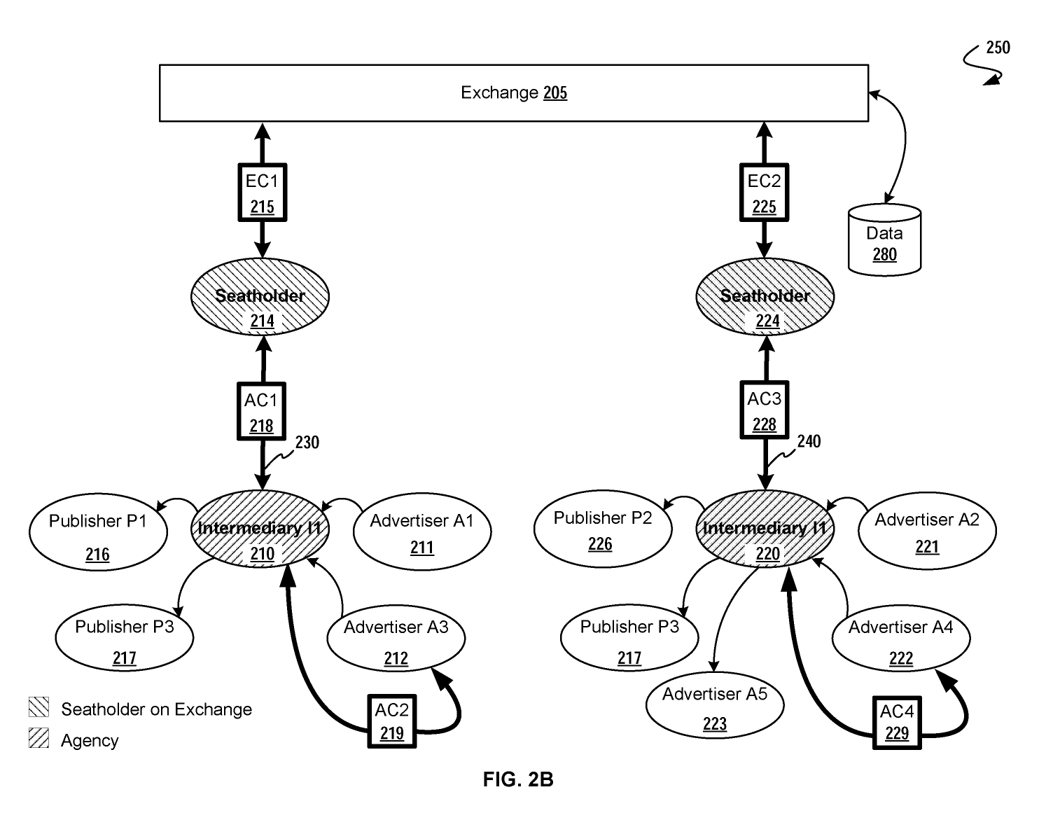

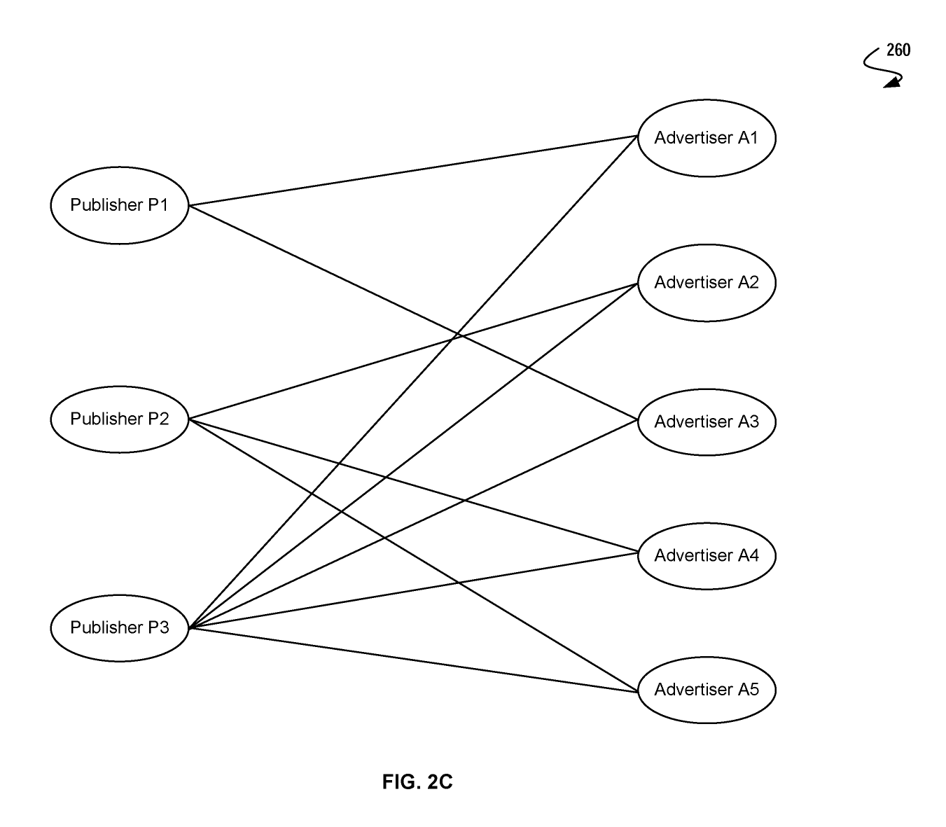

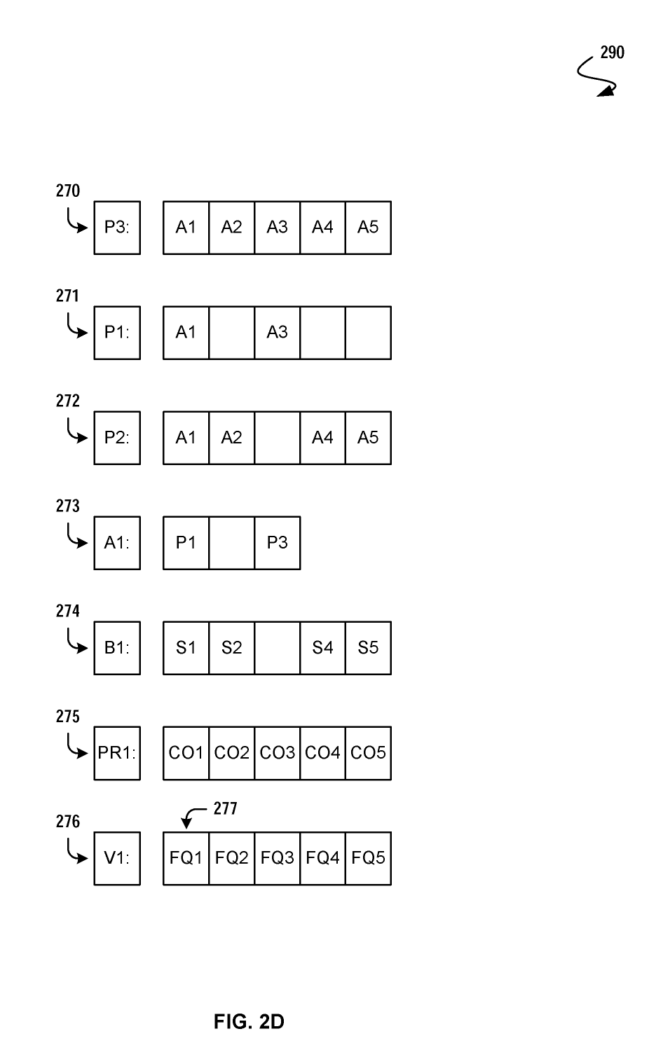

FIG. 2A shows advertising relationship graphs, each showing a path from a buyer to a seller through an intermediary, in which some embodiments operate. The system of FIG. 2A showing advertising relationship graphs is an example of an ecosystem in which intermediary agencies 210, 220 each operate an ad network. As shown on the left side of the dotted line, an ad subnet is formed by the agency intermediary I1 210 together with its advertisers (buyers) 211, 212 and its publishers 216, 217. On the right side is a second ad subnet, formed by an agency intermediary I2 220 together with its advertisers (buyers) 221, 222 and its publishers 226, 217 (note that publisher P3 is in common). An agency is able to perform agency functions for the agency's respective customers, and with the agency's affiliated publishers. However, as shown there are no connections (e.g. no graph edges, no ad relationships, no ad contracts, no links, no deals, etc) between the two intermediary agencies 210 and 220. Thus, in this example, if Publisher P1 216 had an ad call suited for an advertiser, it would be able to receive an advertisement from the advertisers within its subnet (i.e. Advertiser A1 211 or Advertiser A3 212), but not from advertisers in another subnet (e.g. not from Advertiser A2 221 or Advertiser A4 222). An agency or any other ecosystem participant is free to establish new agency relationships with any advertiser, and thereby establish a new advertiser in the subnet; however, establishing such a relationship is human-resource and time intensive. This example of FIG. 2A shows only a few entities; however, in a modern internet advertising system, the ecosystem can comprise many hundreds or thousands (or more) entities.

FIG. 2B shows advertising relationship graphs, showing paths from a buyer to a seller through an intermediary, and including a representation of ad relationships. The system of FIG. 2B showing advertising relationship graphs 250 is an exemplary ecosystem in which two intermediaries (e.g. agent 210, agent 220) are each affiliated with an exchange seatholder (i.e. exchange seatholder 214 and exchange seatholder 224, respectively.

An exchange can be formed by exchange seatholders, which in turn (and as shown) serve one or more agencies for the trading/matching of advertising placement opportunities, and advertising to fill such placement opportunities. Inasmuch as an agency performs actions on behalf of other entities on the exchange, various instruments are used in the provision of agency services. For example:
Agency-Contracts: Agencies can establish a specific type of ad relationship known as an agency-contract (AC) with a client. One or more agency-contracts might be associated with a given link. For example, “Advertiser A3” might enter into an agency-contract (e.g. AC2 219) with an agency “Intermediary I1” 210 for placement of certain ads on a particular Internet property. Additionally, “Advertiser A3” might enter into a second agency-contract (not shown) with “Intermediary I1” for placement of certain ads on a different Internet property. In some cases, agency-contracts may define agency fees, and/or revenue sharing particulars, and/or broker fees to be paid to agencies.
Links: Agencies can establish links with entities on the exchange. Links, and their representation in the directed graphs, merely indicate the existence of some ad relationship, which ad relationship might involve an ad delivery transaction and/or a monetary transaction. For example, an agency (e.g. the ad agency “Intermediary I2” 220) might agree to handle ads for a buyer (e.g. Advertiser A5 223), and “Intermediary I2” might agree to place ads on an Internet property on behalf of the buyer. In such as case, there is a link between “Advertiser A5” (the original buyer in this example) and “Intermediary I2”.

### Data Collection on the Exchange: Concepts, Actions, and Captured Data

Continuing with the description of FIG. 2B, the agencies, namely agency intermediary I1 210 and agency intermediary I2 220, are each affiliated with seatholders on an exchange 205, as indicated by edges 230 and 240, respectively. Becoming a seatholder on an exchange 205 might involve entering into an ad relationship known as an exchange contract (e.g. EC1 215, EC2 225) for codifying the exchange agreement, exchange membership, etc), respectively. Such an exchange agreement might take the form of a legal instrument signed by a duly appointed representative of each of the entities, and the signature on the legal instrument may be obtained in hand and ink, or may be obtained with a virgule signature. In exemplary cases, the exchange agreement subsumes several machine-readable data items (e.g. an electronic form, a data record, a bitmask, etc), and such machine-readable data items can be stored in a data repository 280, and subsequently retrieved by exchange seatholders (and/or other participants on or within the exchange). FIG. 2B also shows an ad relationship in the form of an agency-contract AC1 218 entered into by the intermediary I1 210 and a seatholder 214. Similarly, FIG. 2B also shows ad relationship in the form of an agency-contract AC3 228, entered into by the intermediary I2 220 and exchange seatholder 224.

FIG. 2C shows a representation of relationships between publishers and advertisers in the form of a bi-partite ad relationship graph. As shown, each node on the left side of the graph is a publisher (Publisher P1, Publisher P2, Publisher P3, etc) and each node on the right side of the graph is an advertiser (Advertiser A1, Advertiser A2, Advertiser A3, etc). The edges of the graph depict an ad relationship. Such an ad relationship graph 200 can be used in embodiments of a recommendation system in order to identify potential new connections for an entity. Various data related to the ad relationships can be mined in order to identify recommendable entities.

Strictly as one example for recommending advertisers to publishers, embodiments herein mine impression logs to identify advertisers whose ads appear in a given publisher's impressions. As another example for recommending publishers to advertisers, embodiments herein mine advertisement logs to identify the publishers responsible for the content where a given advertiser's ads appear. In such cases of data mining existing log databases, the data mined represents activities pursuant to existing connections. For making a publisher recommendation, embodiments herein can compare a given publisher with other publishers and find other publishers who are “similar” to the given publisher. Then, embodiments perform further processing to identify connections from where those other “similar” publishers are getting their advertisement traffic. If there are connections (e.g. to advertisers) from which the other similar publishers are getting advertisement traffic, then those advertisers become possible candidates for a recommendation. Considering a recommendation of a publisher to an advertiser, embodiments herein can compare a given advertiser with other advertisers and find other advertisers who are “similar” to the given advertiser. Then, embodiments perform further processing to identify connections where those other “similar” advertisers are placing their advertisement spots. If there are connections (e.g. to publishers) from which the other similar advertisers are placing advertisement traffic, then those publishers become possible candidates for a recommendation.

FIG. 2D shows a representation of relationships between ecosystem participants in the form of vectors. The P3 producer-to-advertiser vector 270 depicts the relationship between publisher P3 and advertisers A1, A2, A3, A4, and A5 (which relationships are also shown in FIG. 2C). The P1 producer-to-advertiser vector 271 depicts the relationship between publisher P1 and advertisers A1 and A3 (which relationships are also shown in FIG. 2C). And, the P2 producer-to-advertiser vector 272 depicts the relationship between publisher P2 and advertisers A1, A2, A4, and A5.

These producer-to-advertiser vectors are merely exemplary, and illustrative as pertains to a publisher-to-advertiser relationship; however, the reverse relationship can be represented as an advertiser-to-producer vector 273. Or, a buyer-to-seller vector 274 can be similarly represented, or, a producer-to-consumer vector 275 can be similarly represented.

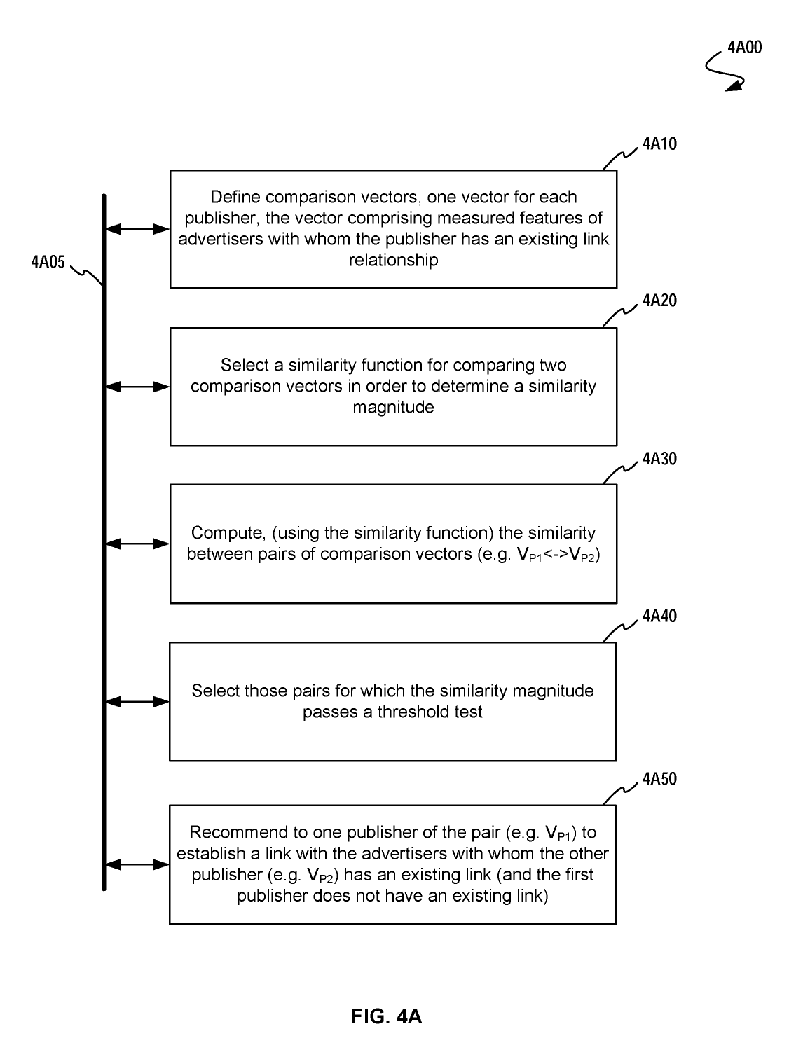

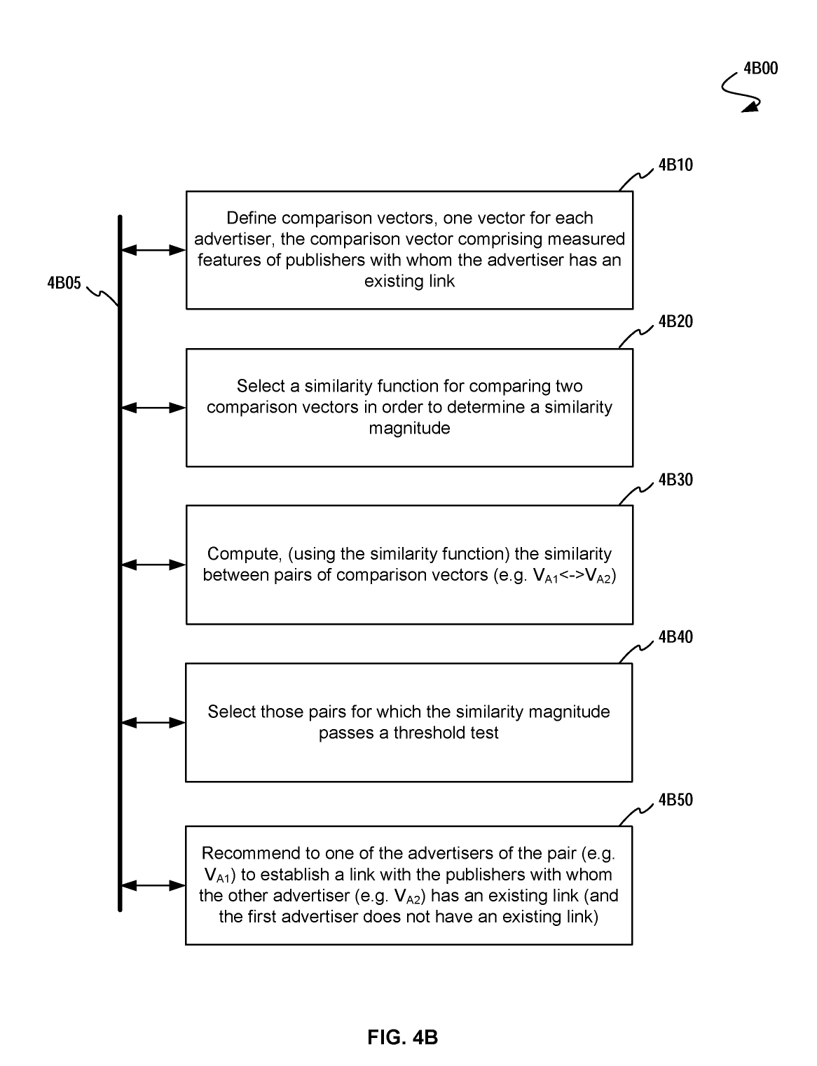

Still more, any feature of an ad relationship between any ecosystem participant (e.g. a publisher, advertiser, buyer, seller, agency, producer, consumer, etc) can be represented as a comparison vector 276 having a vector ID (e.g. V1 as shown) and one or more instances of a feature quantity 277. Such features can be used as criterion for comparisons between entities using the feature vectors. Vectors can be used to characterize features as relates one type of ecosystem participant to another type of ecosystem participant, and pairs of vectors can be compared for similarities (see the discussion of FIG. 4A).

In fact, any group of ecosystem participants (e.g. a publisher, advertiser, buyer, seller, agency, producer, consumer, etc) having some like characteristics can be enumerated into a first set, and a second group of ecosystem participants (e.g. a publisher, advertiser, buyer, seller, agency, producer, consumer, etc) having some other like characteristics can be enumerated into a second set, and a corresponding vector can be defined for relating the members of the second set to members of the first set based on a particular feature (or features). For example, an agency-to-publisher vector (or a publisher-to-agency vector, etc) can be defined to relate the publisher to the agency based on a feature (e.g. impression traffic or ad call traffic). Such a vector is comprised of one or more instances of a feature quantity 277, whereby the feature quantities relate members of the second set of ecosystem participants to the first set of ecosystem participants. Analysis of pairs of vectors (e.g. pair of advertiser-to-producer vectors) can result in identification of similarities among the paired advertisers, and the extent of the similarities can then be used to rank recommendations as pertains to the selected feature (e.g. recommending a producer to an advertiser). The various data collection operations, data mining, feature extraction, vector definition, similarity analysis, and other processing tasks for making a recommendation can be practiced within a networked system for online advertising.

### Overview of Networked Systems for Online Advertising

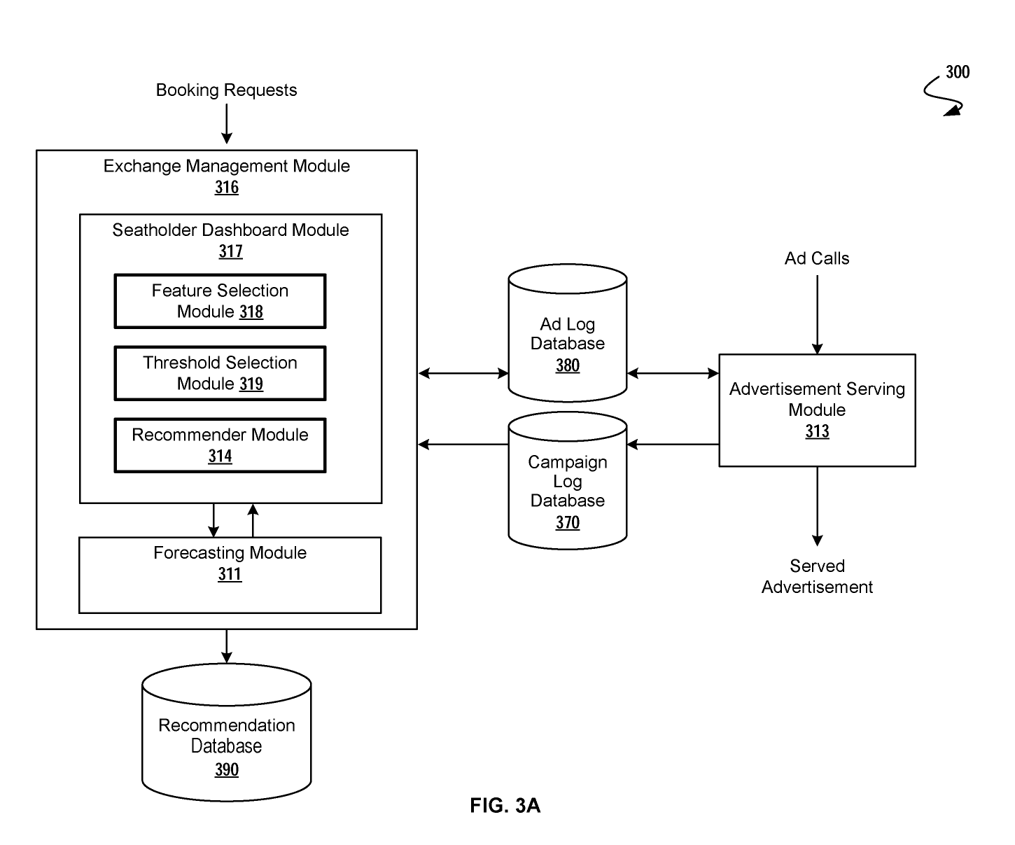

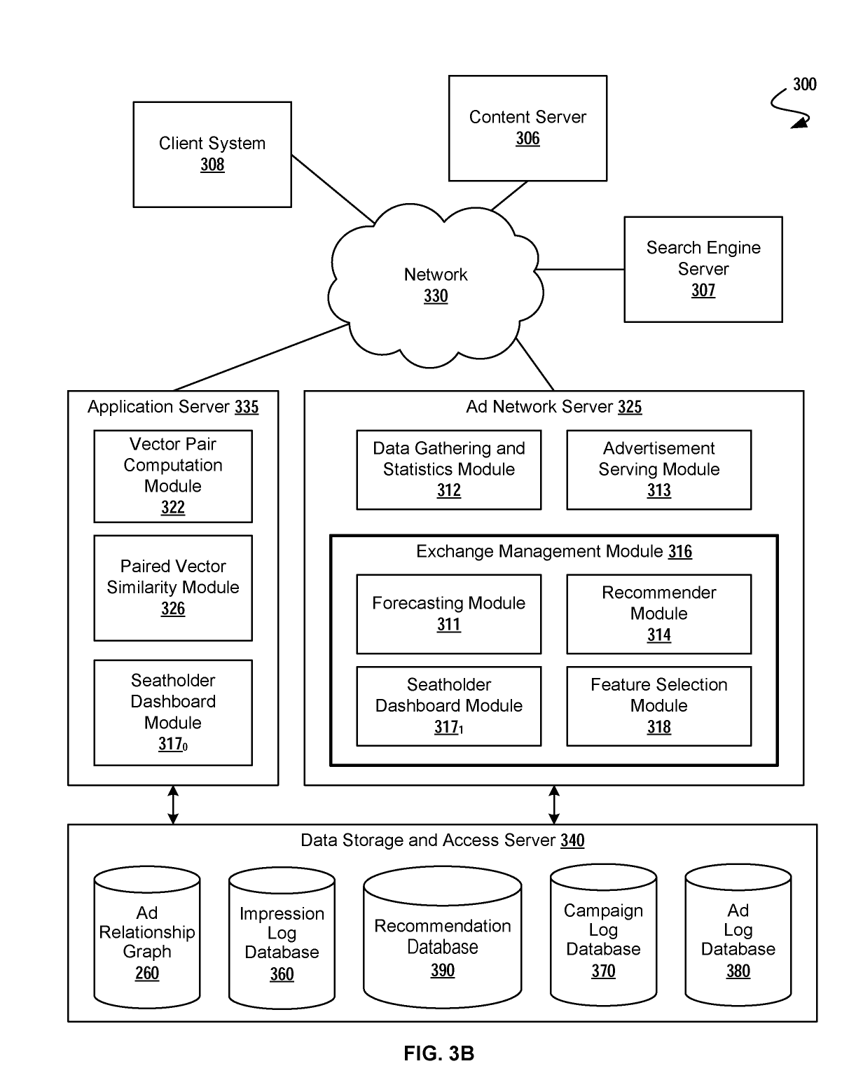

FIG. 3A shows selected modules of an advertising server network environment 300 including modules for recommending new connections in an advertising exchange, in which some embodiments operate. In the context of an advertising server network environment 300, a method for recommending new connections in an advertising exchange can be practiced. As shown, practice of the method commences when a user interfaces with an exchange management module 316, which user interface module therefrom (e.g. seatholder dashboard module 317), the user can specify characteristics of an advertising campaign. For example, the user might want to target “sports fans” (or any other predicate) during February 2011 (or any other time period). Having then formed a campaign query, the user might seek to determine availability and pricing aspects (and other aspects) of such a campaign, possibly using a forecasting module 311.

An advertiser might receive results from a forecasting module 311 that considers forecasts from all publisher's in the advertiser's subnet. In some cases the returned forecast might be deemed to be too small (from the advertiser's perspective) and the advertiser might desire to receive a forecast that is derived from other publishers—that is, a forecast that considers publishers beyond those publishers in the subnet. As can be understood, the existence of the exchange 205 (as shown in FIG. 2B) creates a network-wise interconnection relationship suitable for the practice of internet advertising. Even given the existence of a network-wise interconnection relationship, the advertiser and/or the advertiser's agent might not have a business-wise relationship (e.g. a contract) suitable for covering the commercial aspects of placing the advertiser's advertisement in impressions from the publisher's website.

However, in embodiments of the system and method for recommending new connections in an advertising exchange disclosed herein, the advertiser might follow such recommendations and establish a business-wise relationship (e.g. an ad relationship, or a contract) suitable for covering the commercial aspects of placing the advertiser's advertisement in impressions from the recommended publisher's website.

For dealing with making such recommendations, systems within an advertising server network environment 300 can consider a range of values or features when recommending new connections in an advertising exchange. For example, and again referring to FIG. 2C, an advertiser A1 that experiences a good relationship with a publisher P1 might positively regard a recommendation for a relationship with publisher P2 with whom the publisher P2 experiences a good relationship with advertiser A2. For purposes of disclosing herein embodiments of a recommendation system, the definition of a good relationship can be quantitative. For example, if advertiser A2 experiences a large amount of traffic or placements from publisher P2, then, assuming certain similarities between advertiser A1 and advertiser A2, advertiser A1 might positively regard a recommendation for a relationship with publisher P2. That is, strictly for example, if both advertisers A1 and A2 are advertising “automobiles”, and publisher P2 produces traffic related to “automobiles”, then indeed advertiser A1 might positively regard a recommendation for a relationship with publisher P2.

There can be many quantitative features of a relationship. For example, a recommendation might be based on one or more quantitative aspects of traffic (e.g. number of ad calls per day), quantitative aspects of users (e.g. number of user visits per day who express an interest in “automobiles”), quantitative aspects of campaigns (e.g. number of clicks or number of conversions on an advertisement), etc. Table 1 provides examples.

TABLE 1
Possible quantitative features of an ad relationship

| Name of Feature | Quantitative Representation |
|---|---|
| Impression traffic | Number of impressions per |
| | unit of time |
| Traffic having a particular interest focus | Interest Focus Predicate: |
| | {Interest = “automobiles”} |
| Traffic having a particular interest focus | Interest Focus Predicate: |
| | {Interest = “sports cars”} |
| Traffic having a non-zero click-through-ratio | Number of clicks per |
| | impression |
| Traffic having a non-zero conversion ratio | Number of conversions per |
| | impression |

As can be seen from the examples of Table 1, the capture of various data over time during the prosecution of an advertising campaign can facilitate the use of quantitative features pertaining to a relationship. Collection of such data is facilitated by the collection of modules shown in FIG. 3A; specifically, the advertising server network environment 300 includes an advertisement serving module 313, which module can receive an ad call and, in response, serve one or more advertisements. Such an event can be captured and stored in an ad log database 380 and/or a campaign log database 370. In some embodiments, the ad log database 380 and/or the campaign log database 370 can in turn be used by an exchange management module 316. Moreover, an ad log database 380 and/or campaign log database 370 can include the existence of, and the details of, an ad contract relationship between any two participants within the advertising server network environment 300.

Embodiments of a seatholder dashboard module 317 can comprise a feature selection capability (e.g. see feature selection module 318), and a filter-out capability (e.g. threshold selection module 319). A seatholder dashboard module 317 can comprise or communicate with a recommender module 314. The exchange management module 316, using any combination of its constituent components can produce a recommendation database 390.

FIG. 3B shows an advertising server network environment including modules for recommending new connections in an advertising exchange in display advertising systems, in which some embodiments operate. In the context of internet advertising, placement of advertisements within an internet environment using an advertising server network has become common (e.g. using servers within an advertising server network environment 300). An internet advertiser may enter into an advertising campaign including one or more ad relationships (e.g. a delivery contract) such that whenever any internet user satisfying the terms of the delivery contract visits a web page (e.g. via a client system 308) the advertising system can deem the visit as an opportunity for displaying an impression, and can render the web page with an advertisement as per the terms of the delivery contract. In some cases, the web page may be associated with a particular property, and the user may have traversed to the particular property using a search engine server 307. Continuing, the advertisement is composited on a web page by one or more servers (e.g. an ad network server 325, a content server 306, an application server 335, etc) for delivery to a client system 308 over a network 330. Given this generalized delivery model, and using techniques disclosed herein, sophisticated online advertising might be practiced. More particularly, an advertising campaign might include highly-customized advertisements delivered to a user corresponding to highly-specific target predicates, which highly-specific target predicates may correspond to a delivery contract that was booked on the basis of a forecast resulting from a query involving one or more intersecting campaign query predicates

Again referring to FIG. 3B, an internet property (e.g. a publisher hosting the publisher's base content on a content server 306) might be able to measure the number of visitors that have any arbitrary characteristic, demographic, target predicates, or attributes, possibly using an ad network server 325 in conjunction with a data gathering and statistics module 312. Thus, an internet user might be ‘known’ in quite some detail as pertains to a wide range of target predicates or other attributes, and traffic capturing such target predicates or other attributes can be used in creating a campaign log database 370 and an ad log database 380.

In embodiments of the systems within an advertising server network environment 300, components of the ad network server can perform processing such that, given an advertisement opportunity, an advertisement serving module 313 determines which (if any) advertisement(s) match the advertisement opportunity. The data storage and access server 340 can host any one or more databases. For example, the data storage and access server 340 can host an ad relationship graph database 260, an impression log database 360, a campaign log database 370, an ad log database 380, and a recommendation database 390. As shown, the application server 335 can host a plurality of modules and data structures, for example a vector pair computation module 322 and/or paired vector similarity module 326.

In some embodiments, the advertising server network environment 300 might host an exchange management module 316, which in turn can cooperatively communicate with, or assemble data from, a variety of modules to serve as management and control operations (e.g. a seatholder dashboard module 317, a forecasting module 311, a recommender module 314, a feature selection module 318, etc) pertinent to defining and managing campaigns within an advertising exchange. In particular, the modules, network connections, algorithms, assignment techniques, serving policies, and data structures embodied within the advertising server network environment 300 might be specialized so as to perform a particular function or group of functions reliably while observing capacity and performance requirements. Moreover, some processing can reasonably be performed in batch mode, or “off-line”, while other processing can be performed interactively. Table 2 shows some examples.

TABLE 2
Possible division of processing

| Batch/Off-line Processing | Interactive/On-line Processing |
|---|---|
| Determine pair vectors | Perform feature selection |
| Calculations for determining pair vector | Establish a threshold |
| similarity | |
| Perform data mining | Display a recommendation or |
| | recommendations |

FIG. 4A shows a system for recommending an advertiser to a publisher, according to some embodiments. As shown, the system for recommending an advertiser to a publisher 4A00 includes modules for performing certain operations, namely operations 4A10-4A50. Any module can communicate with any other module over communication path 4A05. In the embodiment shown, operations can be performed by the system for recommending an advertiser to a publisher 4A00 as the following describes: Operations can commence by defining comparison vectors (one vector for each publisher), which vector comprises measured features of advertisers with whom the selected publisher has an existing ad relationship (e.g. ad contract, link, deal, etc); see operation 4A10. Corresponding to the example of FIG. 2C, the comparison vectors (one vector for each publisher) can be described as shown in Table 3.

TABLE 3
Example of comparison vectors for publishers

| Vector ID | A1 | A2 | A3 | A4 | A5 | Notes |
|---|---|---|---|---|---|---|
| V_{P1} | F_{P1A1} | | F_{P1A3} | | | V_{P1} has no ad relation- |
| | | | | | | ship for {A2, A4, A5} |
| V_{P2} | | F_{P2A2} | | F_{P2A4} | F_{P2A5} | V_{P2} has no ad relation- |
| | | | | | | ship for {A1, A3} |
| V_{P3} | F_{P3A1} | F_{P3A2} | F_{P3A3} | F_{P3A4} | F_{P3A5} | |

Continuing, operation 4A20 serves for selecting a similarity function for comparing two comparison vectors in order to determine a similarity magnitude. As can be observed, the vectors shown in Table 3 are multi-dimensional vectors (in this case 5 dimensions), and comparison of any two vectors for their similarity (or proximity in multi-dimensional space) can be given by well known techniques. In this example, let A^{j} be V_{P1}, and let A^{k} be V_{P2}, and let i vary over the range [A1, A2, A3, A4, A5]. Then, using as known in the art as a cosine similarity measure, the similarity (e.g. comparison value c_{cos jk}) can be calculated using the formula:

$$c {cos}_{jk} = \frac{{\sum }_{i = 1}^{n} ( {A}_{i}^{j} {A}_{i}^{k} )}{\sqrt{{\sum }_{i = 1}^{n} {( {A}_{i}^{j} )}^{2} {\sum }_{i = 1}^{n} {( {A}_{i}^{k} )}^{2}}}$$

The cosine similarity measure is not the only similarity (dis-similarity) measure known in the art, and other similarity measures are reasonable and envisioned. Moreover, the selection of A^{j} as assigned to V_{P1}, and the selection of A^{k} as assigned to V_{P2} is but one example of a selection of a pair of comparison vectors. Also, some similarity measures include single scalar magnitudes, multiple scalar magnitudes, and vector similarity measures. In various embodiments, a plurality of pairs are selected for similarity comparison. In one embodiment, all unique pairs are selected, and the similarity of each unique pair is computed (see operation 4A30). In another embodiment, only a subset of pairs are selected for similarity comparison. Again, the similarity calculation using the cosine similarity measure is not the only technique for determining the similarity, and other techniques are known, reasonable, and envisioned. For example, Another similarity measure that can be used is the Jaccard Coefficient (also sometimes known as the Jacquard Coefficient). The Jaccard coefficient measures similarity between sample sets, and is defined as the size of the intersection divided by the size of the union of the sample sets. Given sets A and B, the Jaccard Coefficient, J(A,B) is given as:

$$J ( A , B ) = \frac{\vert A ⋂ B \vert}{\vert A ⋃ B \vert} .$$

Following the example of Table 3, the computation of similarity of all unique pairs results in a set of magnitudes, as is shown in Table 4.

TABLE 4
Example of magnitudes of similarity between comparison vectors

| Comparison Pair | Similarity | |
|---|---|---|
| (Vector Pair by ID) | Magnitude | Notes |
| V_{P1P2} | M_{P1P2} | V_{P1P2} is the same comparison pair as |
| | | V_{P2P1} |
| V_{P2P3} | M_{P2P3} | V_{P2P3} is the same comparison pair as |
| | | V_{P3P2} |
| V_{P1P3} | M_{P1P3} | V_{P1P3} is the same comparison pair as |
| | | V_{P3P1} |

Now, having a similarity magnitude for each unique comparison pair, as in the set {M_{P1P2}, M_{P2P3}, M_{P1P3}} the magnitudes can be ranked or compared against a threshold value, and only those comparison pairs that pass the threshold test are further considered (see operation 4A40). Continuing this example, suppose publisher P2 and publisher P3 are deemed to be similar (e.g. if M_{P2P3} passes any threshold test), then recommendations can be made. Intuitively, if publisher P2 is similar to publisher P3, and publisher P3 enjoys an ad relationship with advertiser A5 (but publisher P2 does not enjoy an ad relationship with advertiser A5) then a recommendation to P2 to establish an ad relationship with A5 can be made (see operation 4A50). Stated slightly differently, if publisher P2 is similar to publisher P3, and publisher P3 enjoys an ad relationship with advertiser A5 (but publisher P2 does not enjoy an ad relationship with advertiser A5) then a recommendation to A5 to establish an ad relationship with P2 can be made.

FIG. 4B shows a system for recommending a publisher to an advertiser, according to some embodiments. As shown, the system for recommending a publisher to an advertiser 4B00 includes modules for performing certain operations, namely operations 4B10-4B50. Any module can communicate with any other module over communication path 4B05. In the embodiment shown, operations can be performed by the system for recommending a publisher to an advertiser 4B00 as the following describes: Operations can commence by defining comparison vectors (one vector for each advertiser), which vector comprises measured features of publishers with whom the selected advertiser has an existing ad relationship (e.g. ad contract, link, deal, etc); see operation 4B10. Corresponding to the example of FIG. 2C, the comparison vectors (one vector for each advertiser) can be described as shown in Table 5.

TABLE 5
Example of comparison vector for an advertiser

| Vector ID | P1 | P2 | P3 | Notes |
|---|---|---|---|---|
| V_{A1} | F_{A1P1} | | F_{A1P3} | V_{A1} has no ad relationship for {P2} |
| V_{A2} | | F_{A2P2} | F_{A2P3} | V_{A2} has no ad relationship for {P1} |
| V_{A3} | F_{A3P1} | | F_{A3P3} | V_{A3} has no ad relationship for {P2} |
| V_{A4} | | F_{A4P2} | F_{A4P3} | V_{A4} has no ad relationship for {P1} |
| V_{A5} | | F_{A5P2} | F_{A5P3} | V_{A5} has no ad relationship for {P1} |

Continuing, operation 4B20 serves for selecting a similarity function for comparing two comparison vectors in order to determine a similarity magnitude. As can be observed, the vectors shown in Table 5 are multi-dimensional vectors (in this case three dimensions), and comparison of any two vectors for their similarity (or proximity in multi-dimensional space) can be given by well known techniques. In this example, let A^{j} be V_{A1}, and let A^{k} be V_{A2}, and let i vary over the range [P1, P2, P3]. Then, the similarity (e.g. comparison value c_{cos jk}) can be calculated the following formula (or other formula or algorithm):

$$c {cos}_{jk} = \frac{{\sum }_{i = 1}^{n} ( {A}_{i}^{j} {A}_{i}^{k} )}{\sqrt{{\sum }_{i = 1}^{n} {( {A}_{i}^{j} )}^{2} {\sum }_{i = 1}^{n} {( {A}_{i}^{k} )}^{2}}}$$

The cosine similarity measure is not the only similarity (dis-similarity) measure known in the art and other similarity measures are reasonable and envisioned. Moreover, the selection of A^{j} as assigned to V_{A1}, and the selection of A^{k} as assigned to V_{A2} is but one example of a selection of a pair of comparison vectors. Also, some similarity measures include single scalar magnitudes, multiple scalar magnitudes, and vector similarity measures. In various embodiments, a plurality of pairs are selected for similarity comparison. In one embodiment, all unique pairs are selected, and the similarity of each unique pair is computed (see operation 4B30).

Now, having a similarity magnitude for each unique comparison pair, the magnitudes can be ranked or compared against a threshold value, and only those comparison pairs that pass the threshold test are further considered (see operation 4B40). Continuing this example, suppose advertiser A1 and advertiser A2 are deemed to be similar (e.g. if the similarity magnitude passes any threshold test), then recommendations can be made. Intuitively, if advertiser A1 is similar to advertiser A2 and advertiser A2 enjoys an ad relationship with publisher P2 (but advertiser A1 does not enjoy an ad relationship with publisher P2) then a recommendation advertiser A1 to establish an ad relationship with publisher P2 can be made (see operation 4B50).

Stated slightly differently, if advertiser A1 is similar to advertiser A2 and advertiser A2 enjoys an ad relationship with publisher P2 (but advertiser A1 does not enjoy an ad relationship with publisher P2) then a recommendation to publisher P2 to establish an ad relationship with advertiser A1 can be made (see operation 4B50).

The aforementioned techniques can be applied to making any sort of ecosystem participant recommendations to any other ecosystem participant. Although the foregoing examples emphasize the application of the recommendation techniques to publishers and advertisers, other recommendations are also possible. In particular, advertisers are often represented by an advertising agency, and the agency serves as the managing entity for the advertiser (MA). Similarly, some publishers are managed by an aggregator and the aggregator serves as the managing entity for the publisher (MP). Still further, many participants, including publishers, advertisers, MAs, MPs, and other participants can be subsumed into an advertising network, which could in turn be managed by an advertising network manager (MAN). As in earlier embodiment descriptions, the comparison vector can be comprised of any arbitrary feature of the constituent participants in the MAN, and a MAN can act in a multiplicity of roles, including a MAN serving in the capacity of a MA, and/or a MAN can act by serving in the capacity of a MP.

Such a selection of any arbitrary features to be included in the comparison vector can be repeated such that a recommendation can be made on the basis of multi-dimensional similarity, possibly including a weighting scheme whereby a first dimension (e.g. a selected feature) is weighted differently than a second dimension.

Further, the confidence of a valid similarity determination can be performed using statistical techniques known in the art. Moreover, additional statistical techniques can be applied in order to measure the accuracy of the similarity determination, for example, using statistical measures of precision and recall.

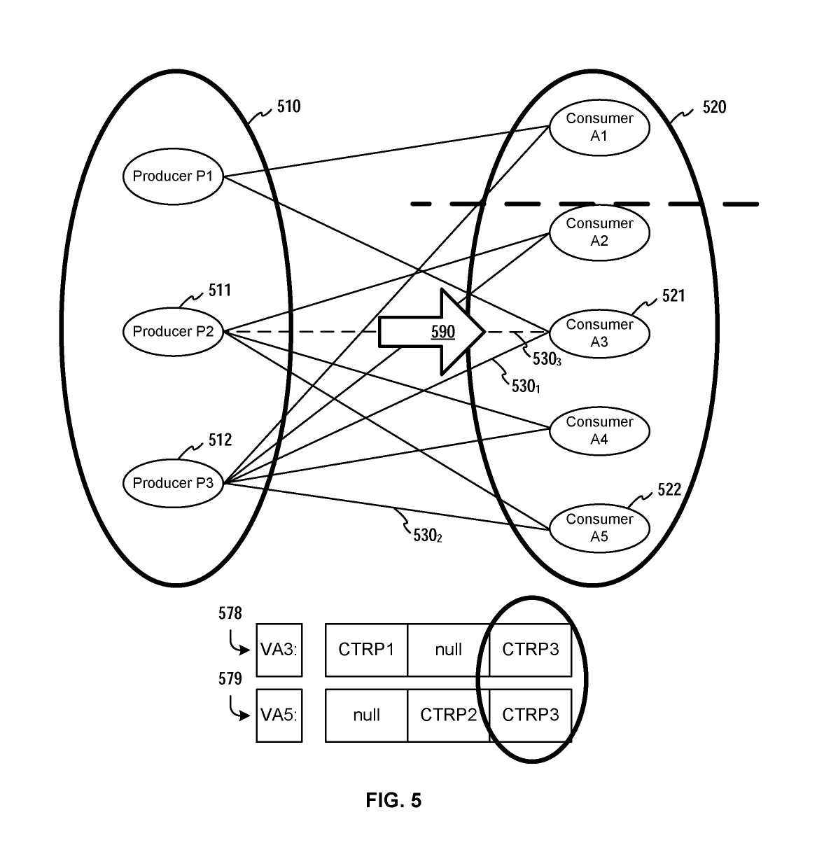

FIG. 5 shows aspects of a system for recommending a consumer to a producer, according to some embodiments. The aforementioned FIG. 4B, shows a system for recommending a publisher to an advertiser 4B00. However, the publisher-to-advertiser relationship (or advertiser-to-publisher relationship) are not the only relationships that can be recommended using the herein disclosed techniques for recommending new connections in an advertising exchange. Generally, any sort of producer (e.g. a producer of impressions, a producer of advertisements, etc) may want to establish an ad relationship with any consumer (e.g. a consumer of impressions, a consumer of advertisements, etc). Accordingly, a system or method for recommending new connections in an advertising exchange can operate using a generalized version of an ad relationship graph 200 by enumerating a set of producer participants 510 having at least a first producer participant 511 and a second producer participant 512, then enumerating a set of consumer participants 520. Then, given a selected feature quantity, further computation and recommendations (see FIG. 4B operation 4B30, operation 4B40, and operation 4B50) can be performed, resulting in the desired recommendation or recommendations.

Further describing the example of FIG. 5, and strictly as an illustrative example, a method for recommending new connections in an advertising exchange can be practiced by following a series of steps:
Enumerating a set of producer participants 510 having at least a first producer participant 512 and a second producer participant 511. As shown, the first producer participant 512 is producer P3, and the second producer participant 511 is P2.
Enumerating a set of consumer participants 520, at least two of the members of the set of consumer participants having an ad relationship to at least one of the first producer participant or the second producer participant. As shown, the at least two of the members of the set of consumer participants are shown as consumer A3 521 and consumer A5 522, both of which participants have an ad relationship with the first producer participant, namely producer P3. The ad relationship 530 with the first producer participant is shown in FIG. 5 as ad relationship 530₁ (between consumer A3 the first producer participant, producer P3) and as ad relationship 530₂ (between consumer A5 the first producer participant, producer P3).
Selecting a feature quantity. Strictly as an example, a feature quantity 277 can be click through rate (CTR).
Defining a first vector of the feature quantities, the first vector of the feature quantities relating the feature quantity for a first member of the set of consumer participants to the first producer participant. As shown, the first vector of the feature quantities 578 relates the CTR of A3 to the first producer participant, namely producer P3, and the corresponding CTR is shown as CTRP3.
Defining a second vector of feature quantities 579, the second vector of feature quantities relating the feature quantity for a second member of the set of consumer participants to the first producer participant. As shown, the second vector of the feature quantities 579 relates the CTR of A5 to the first producer participant, namely producer P3. As can now be understood, there is at least one producer that is shared by the two selected consumers. In practice, there can be many such shared producers, and determining similarity between two consumers can be (in part) on the basis of the extent of the producers in common, and/or the extent of the feature quantity as relates to the producers in common.
Determining a similarity measure between the first vector of the feature quantities and the second vector of the feature quantities. As earlier discussed, the similarity measure can be determined based on a variety of factors known in the art. In the example shown, a similarity measure can identify a similarity between the first vector of the feature quantities 578 and the second vector of feature quantities 579 by virtue of the CTR feature which is common for producer P3. Continuing, since Consumer A5 and Consumer A3 are similar, at least in the regard that they both share an ad relationship with P3 (the operation of which ad relationship results in a measured CTR), then other producers associated with A5 (e.g. Producer P2) might be recommendable to A3.
Recommending, based on the similarity measure, at least one recommended member of the set of producer participants to the first member of the set of consumer participants. As shown, the recommendation 590 is a recommendation to the first member of the set of consumer participants, namely consumer A3 to establish a new ad relationship 530₃ with producer P2.

The recommending step can come in many forms, including advising a real person. In other embodiments, the action of recommending includes creating one or more pro-form a contracts (e.g. ad contracts, deals, links, etc) between the participants involved in the recommendation. Recommendations can be conveyed to a person on demand (e.g. where the person submits a query, and the results are provided to the person). Or, on a reoccurring basis, embodiments disclosed herein can inform a real person (e.g. whenever a configuration change occurs, whenever a new possible connection appears in the result set, etc). The recommendation information can be conveyed via a web page that a person (e.g. an ecosystem participant) visits. Still more, such a system can perform an on-demand/immediate analysis and invoke modules for generating results, or it can retrieve stored results from a cache that is periodically updated. Even still more, results of a recommending step can used to automatically generate contract forms and forward such contract forms to participants.

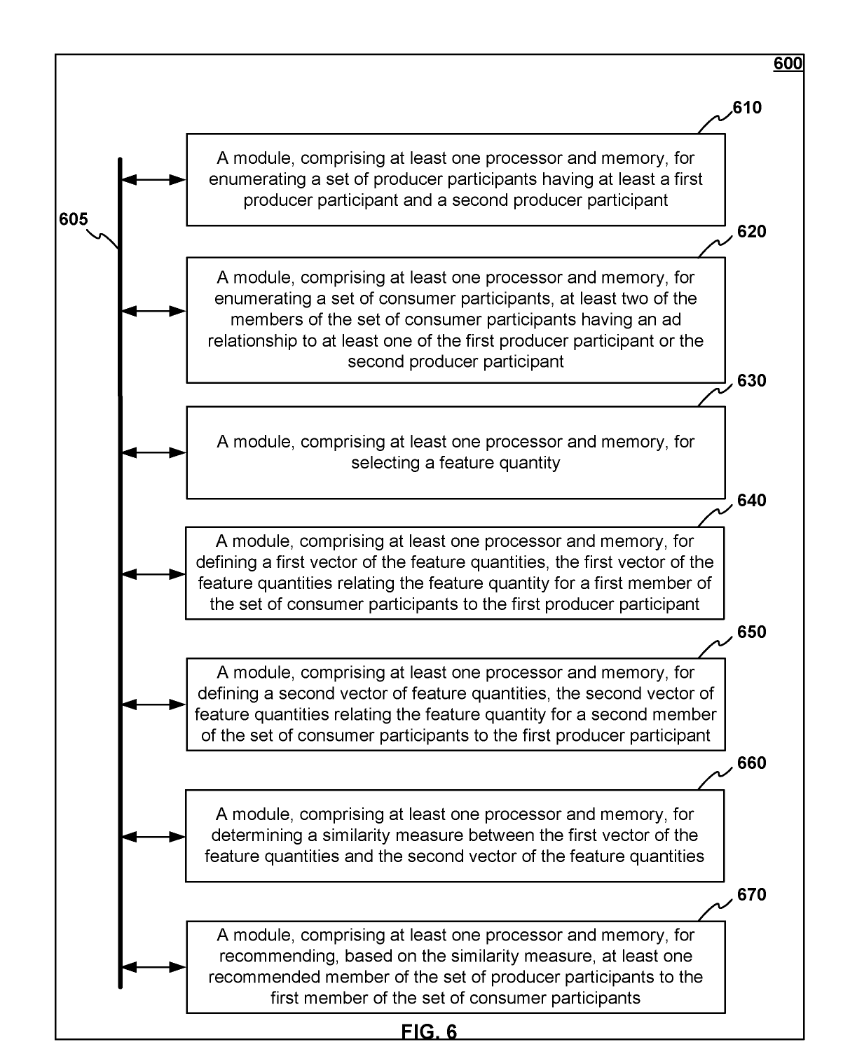

FIG. 6 depicts a block diagram of a system for recommending new connections in an advertising exchange. As an option, the present system 600 may be implemented in the context of the architecture and functionality of the embodiments described herein. Of course, however, the system 600 or any operation therein may be carried out in any desired environment. As shown, system 600 comprises a plurality of modules, a module comprising at least one processor and a memory, each connected to a communication link 605, and any module can communicate with other modules over communication link 605. The modules of the system can, individually or in combination, perform method steps within system 600. Any method steps performed within system 600 may be performed in any order unless as may be specified in the claims. As shown, system 600 implements a method for recommending new connections in an advertising exchange, the system 600 comprising modules for: enumerating a set of producer participants having at least a first producer participant and a second producer participant (see module 610); enumerating a set of consumer participants, at least two of the members of the set of consumer participants having an ad relationship to at least one of the first producer participant or the second producer participant (see module 620); selecting a feature quantity (see module 630); defining a first vector of the feature quantities, the first vector of the feature quantities relating the feature quantity for a first member of the set of consumer participants to the first producer participant (see module 640); defining a second vector of feature quantities, the second vector of feature quantities relating the feature quantity for a second member of the set of consumer participants to the first producer participant (see module 650); determining a similarity measure between the first vector of the feature quantities and the second vector of the feature quantities (see module 660); and recommending, based on the similarity measure, at least one recommended member of the set of producer participants to the first member of the set of consumer participants (see module 670).

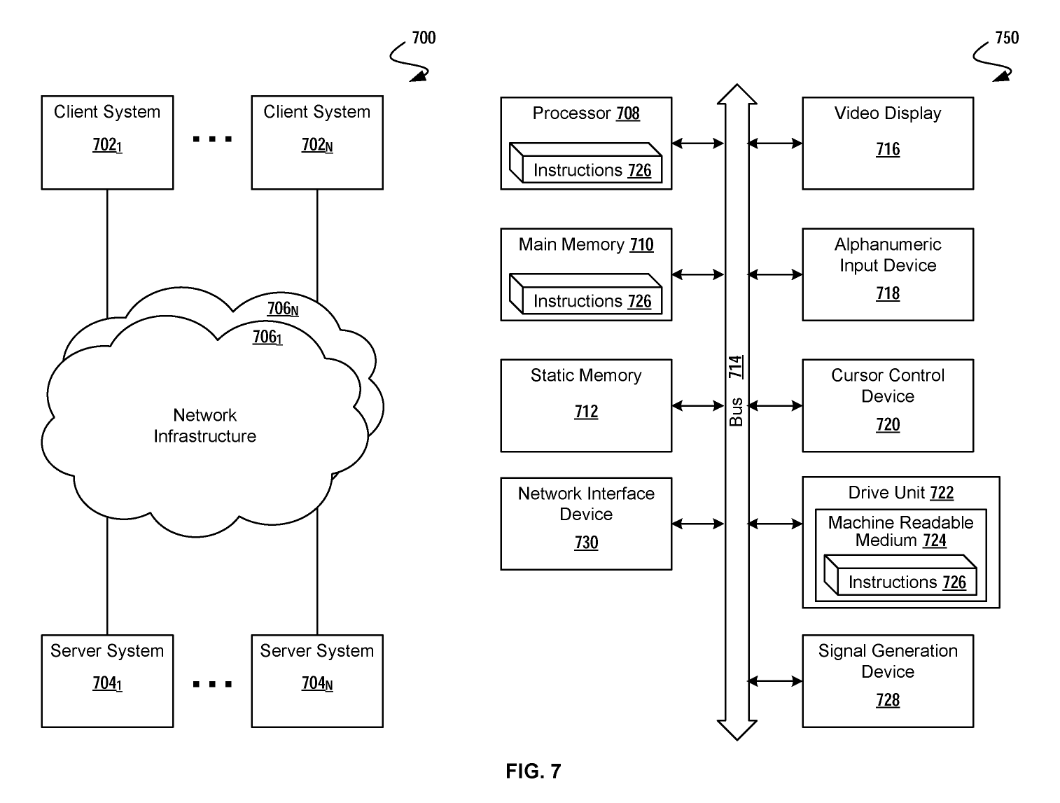

FIG. 7 is a diagrammatic representation of a network 700, including nodes for client computer systems 702₁ through 702_{N}, nodes for server computer systems 704₁ through 704_{N}, and network infrastructure nodes 706₁ through 706_{N}, according to some embodiments. The embodiment shown is purely exemplary, and might be implemented in the context of one or more of the figures herein.

Any node of the network 700 may comprise a general-purpose processor, a digital signal processor (DSP), an application specific integrated circuit (ASIC), a field programmable gate array (FPGA) or other programmable logic device, discrete gate or transistor logic, discrete hardware components, or any combination thereof capable to perform the functions described herein. A general-purpose processor may be a microprocessor, but in the alternative, the processor may be any conventional processor, controller, microcontroller, or state machine. A processor may also be implemented as a combination of computing devices (e.g. a combination of a DSP and a microprocessor, a plurality of microprocessors, one or more microprocessors in conjunction with a DSP core, or any other such configuration, etc).

In alternative embodiments, a node may comprise a machine in the form of a virtual machine (VM), a virtual server, a virtual client, a virtual desktop, a virtual volume, a network router, a network switch, a network bridge, a personal digital assistant (PDA), a cellular telephone, a web appliance, or any machine capable of executing a sequence of instructions that specify actions to be taken by that machine. Any node of the network may communicate cooperatively with another node on the network. In some embodiments, any node of the network may communicate cooperatively with every other node of the network. Further, any node or group of nodes on the network may comprise one or more computer systems (e.g. a client computer system, a server computer system) and/or may comprise one or more embedded computer systems, a massively parallel computer system, and/or a cloud computer system.

The computer system 750 includes a processor 708 (e.g. a processor core, a microprocessor, a computing device, etc), a main memory 710 and a static memory 712, which communicate with each other via a bus 714. The machine 750 may further include a display unit 716 that may comprise a touch-screen, or a liquid crystal display (LCD), or a light emitting diode (LED) display, or a cathode ray tube (CRT). As shown, the computer system 750 also includes a human input/output (I/O) device 718 (e.g. a keyboard, an alphanumeric keypad, etc), a pointing device 720 (e.g. a mouse, a touch screen, etc), a drive unit 722 (e.g. a disk drive unit, a CD/DVD drive, a tangible computer readable removable media drive, an SSD storage device, etc), a signal generation device 728 (e.g. a speaker, an audio output, etc), and a network interface device 730 (e.g. an Ethernet interface, a wired network interface, a wireless network interface, a propagated signal interface, etc).

The drive unit 722 includes a machine-readable medium 724 on which is stored a set of instructions (i.e. software, firmware, middleware, etc) 726 embodying any one, or all, of the methodologies described above. The set of instructions 726 is also shown to reside, completely or at least partially, within the main memory 710 and/or within the processor 708. The set of instructions 726 may further be transmitted or received via the network interface device 730 over the network bus 714.

It is to be understood that embodiments of this invention may be used as, or to support, a set of instructions executed upon some form of processing core (such as the CPU of a computer) or otherwise implemented or realized upon or within a machine- or computer-readable medium. A machine-readable medium includes any mechanism for storing information in a form readable by a machine (e.g. a computer). For example, a machine-readable medium includes read-only memory (ROM); random access memory (RAM); magnetic disk storage media; optical storage media; flash memory devices; electrical, optical or acoustical or any other type of media suitable for storing information.

While the invention has been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims.

We claim:

1. A computer-implemented method for recommending new connections in an advertising exchange, the advertising exchange having at least two producer participants and at least two consumer participants, the method comprising:
enumerating, in a computer memory, a set of two producer participants;
enumerating, in a computer memory, a set of consumer participants, the set of consumer participants having at least two members and at least one member of the set of consumer participants having a first and second ad relationship with at least two of the producer participants, and at least one member of the set of consumer participants having a third ad relationship with exactly one of the producer participants, and every member of the set of consumer participants having at least one ad relationship with at least one of the producer participants;
selecting, in a computer memory, a feature quantity;
defining, in a computer, a first vector of the feature quantities, at least one element of the first vector of feature quantities relating the feature quantity for a first member of the set of consumer participants to the first producer participant;
defining, in a computer, a second vector of feature quantities,
at least one element of the second vector of feature quantities relating the feature quantity for a first member of the set of consumer participants to the second producer participant;
determining, in a computer, a similarity measure between the first vector of the feature quantities and the second vector of the feature quantities; and
recommending, in a computer memory, based on the similarity measure, at least one recommended member of the set of producer participants to a member of the set of consumer participants.

2. The method of claim 1, wherein the set of producer participants is at one of, a publisher, an MP, an aggregator, a MAN serving in the capacity of a MP.

3. The method of claim 1, wherein the set of consumer participants is at one of, an advertiser, an MA, an ad agency, a MAN serving in the capacity of a MA.

4. The method of claim 1, wherein the at least one recommended member of the set of producer participants does not have an ad relationship with the first member of the set of consumer participants.

5. The method of claim 1, wherein the feature quantity is at least one of, a measure of traffic, a measure of impressions per time period, a clock-through-rate, a conversion rate.

6. The method of claim 1, wherein determining the similarity between the first vector of the feature quantities and the second vector of the feature quantities is calculated using the formula
$$c {cos}_{jk} = \frac{{\sum }_{i = 1}^{n} ( {A}_{i}^{j} {A}_{i}^{k} )}{\sqrt{{\sum }_{i = 1}^{n} {( {A}_{i}^{j} )}^{2} {\sum }_{i = 1}^{n} {( {A}_{i}^{k} )}^{2}}}$$
and wherein, A^{j} is first vector and A^{k} is the second vector.

7. The method of claim 1, further comprising selecting a similarity comparison technique from a plurality of similarity comparison techniques.

8. An advertising server network method for recommending new connections in an advertising exchange, comprising:
a module for enumerating a set of producer participants having at least a first producer participant and a second producer participant;
a module for enumerating a set of consumer participants, at least two of the members of the set of consumer participants having an ad relationship to at least one of the first producer participant or the second producer participant;
a module for selecting a feature quantity;
a module for defining a first vector of the feature quantities, the first vector of the feature quantities relating the feature quantity for a first member of the set of consumer participants to the first producer participant;
a module for defining a second vector of feature quantities, the second vector of feature quantities relating the feature quantity for a second member of the set of consumer participants to the first producer participant;
a module for determining a similarity measure between the first vector of the feature quantities and the second vector of the feature quantities; and
a module for recommending, based on the similarity measure, at least one recommended member of the set of producer participants to the first member of the set of consumer participants.

9. The advertising server network of claim 8, wherein the set of producer participants is at one of, a publisher, an MP, an aggregator, a MAN serving in the capacity of a MP.

10. The advertising server network of claim 8, wherein the set of consumer participants is at one of, an advertiser, an MA, an ad agency, a MAN serving in the capacity of a MA.

11. The advertising server network of claim 8, wherein the at least one recommended member of the set of producer participants does not have an ad relationship with the first member of the set of consumer participants.

12. The advertising server network of claim 8, wherein the feature quantity is at least one of, a measure of traffic, a measure of impressions per time period, a clock-through-rate, a conversion rate.

13. The advertising server network of claim 8, wherein determining the similarity between the first vector of the feature quantities and the second vector of the feature quantities is calculated using the formula
$$c {cos}_{jk} = \frac{{\sum }_{i = 1}^{n} ( {A}_{i}^{j} {A}_{i}^{k} )}{\sqrt{{\sum }_{i = 1}^{n} {( {A}_{i}^{j} )}^{2} {\sum }_{i = 1}^{n} {( {A}_{i}^{k} )}^{2}}}$$
and wherein, A^{j} is first vector and A^{k} is the second vector.

14. The advertising server network of claim 8, further comprising a module for selecting a similarity comparison technique from a plurality of similarity comparison techniques.

15. A non-transitory computer readable medium comprising a set of instructions which, when executed by a computer, cause the computer to recommend new connections in an advertising exchange, the set of instructions for:
enumerating a set of producer participants having at least a first producer participant and a second producer participant;
enumerating a set of consumer participants, at least two of the members of the set of consumer participants having an ad relationship to at least one of the first producer participant or the second producer participant;
selecting a feature quantity;
defining a first vector of the feature quantities, the first vector of the feature quantities relating the feature quantity for a first member of the set of consumer participants to the first producer participant;
defining a second vector of feature quantities, the second vector of feature quantities relating the feature quantity for a second member of the set of consumer participants to the first producer participant;
determining a similarity measure between the first vector of the feature quantities and the second vector of the feature quantities; and
recommending, based on the similarity measure, at least one recommended member of the set of producer participants to the first member of the set of consumer participants.

16. The non-transitory computer readable medium of claim 15, wherein the set of producer participants is at one of, a publisher, an MP, an aggregator, a MAN serving in the capacity of a MP.

17. The non-transitory computer readable medium of claim 15, wherein the set of consumer participants is at one of, an advertiser, an MA, an ad agency, a MAN serving in the capacity of a MA.

18. The non-transitory computer readable medium of claim 15, wherein the at least one recommended member of the set of producer participants does not have an ad relationship with the first member of the set of consumer participants.

19. The non-transitory computer readable medium of claim 15, wherein the feature quantity is at least one of, a measure of traffic, a measure of impressions per time period, a clock-through-rate, a conversion rate.

20. The non-transitory computer readable medium of claim 15, wherein determining the similarity between the first vector of the feature quantities and the second vector of the feature quantities is calculated using the formula
$$c {cos}_{jk} = \frac{{\sum }_{i = 1}^{n} ( {A}_{i}^{j} {A}_{i}^{k} )}{\sqrt{{\sum }_{i = 1}^{n} {( {A}_{i}^{j} )}^{2} {\sum }_{i = 1}^{n} {( {A}_{i}^{k} )}^{2}}}$$
and wherein, A^{j} is first vector and A^{k} is the second vector.
